(19) United States
(12) Patent Application Publication
(10) Pub. No.: US 2015/0106500 A1
(43) Pub. Date: Apr. 16, 2015

(54) APPLICATION PROVISIONING SYSTEM

(71) Applicant: Bank of America Corporation, Charlotte, NC (US)

(72) Inventors: Thomas Fakhouri, London (GB); Mohit Sarvaiya, Westminster (GB)

(73) Assignee: Bank of America Corporation, Charlotte, NC (US)

(21) Appl. No.: 14/053,340

(22) Filed: Oct. 14, 2013

(51) Int. Cl. H04L 12/26

(52) U.S. Cl. CPC H04L 43/04
USPC 709/224

(57) ABSTRACT

Systems and methods are described for monitoring access to one or more web applications associated with an organization, and such that usage statistics related to software licenses associated with the accessed web applications may be captured and stored. Additionally these systems and methods may be used to monitor access to one or more applications stored locally on a computer system such that an organization may update the one or more applications stored locally on a computer system to be in compliance with software revisions.

### TECHNICAL FIELD

Aspects of this disclosure generally relate to application provisioning of software applications to users within an organization. Accordingly, aspects of this disclosure allow for control and monitoring of access to applications associated with an application database system.

### BACKGROUND

Organizations, such as business enterprises, universities, or research groups, among others, may use tens or hundreds of software applications to undertake those tasks associated with the operations of the organization. However, in some instances, the structure of an organization may be such that a collective group of users (who may be employees, students, or researchers, and the like) within the organization is broken down into multiple sub-groups. Accordingly, sub-groups may be referred to as work groups, departments, majors, classes, subject areas, or specialties, and the like, and wherein sub-groups complete different types of tasks associated with operations within the organization. Additionally, software applications requested by users may differ based upon sub-group. Furthermore, in some instances, the type of tasks may differ from user to user within a given sub-group, based upon, a geographic location of a user, a level of experience of a user, or a personal preference of a user, among others. As such, it may be desirable for an organization to provide access to different types of software applications based upon individual user profiles, and such that an organization does not license each software application used by the organization as a whole for every user associated with that organization.

In some instances, it may be desirable for an organization to establish one or more centralized databases from which users may access software applications. Accordingly, a user, upon commencing a new position and/or task within the organization, may communicate with a centralized database to gain access to one or more software applications associated with the new position and/or task. In some instances, a user may download a software application from a centralized database such that the software application is accessed on a local computer system. Accordingly, in some instances, it may be difficult for administrators associated with the organization to monitor access/entitlements to the software application present on the local computer system. For example, it may be difficult for administrators to ensure that a software application present on a local computer system is a latest version of the software application, as may be mandated by certain regulations associated with an organization. In other instances, a centralized database may store links to software applications, wherein the software applications may be web applications, accessible to users through the Internet. Accordingly, in some instances, it may be difficult for administrators associated with the organization to monitor access/entitlements associated with web applications. For example, while a web application publisher (vendor-side) may monitor access by software license holders to respective web applications, it might not be possible for administrators associated with an organization (user-side) in possession of said licenses to monitor access by users to the respective web applications.

Therefore, a need exists for improved control and monitoring of access/entitlements to applications associated with a centralized application database system of an organization.

### BRIEF SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

In one aspect, this disclosure relates to application provisioning that may grant access to the one or more applications based on application provisioning rules and user provisioning rules, and further, to monitoring of access to applications.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The present invention is illustrated by way of example and is not limited in the accompanying figures in which like reference numerals indicate similar elements.

FIG. 1 illustrates a block diagram of an exemplary configuration of a system for monitoring access and/or entitlements associated with software applications in a centralized application database system of an organization.

FIG. 2 is a schematic block diagram of an example application network according to one or more illustrative aspects described herein.

FIG. 3 is a schematic block diagram of an example application provisioning system according to one or more illustrative aspects described herein.

FIG. 4 is a flowchart diagram of an example application access process according to one or more illustrative aspects described herein.

FIG. 5 is a flowchart diagram of an example process for monitoring of web applications and/or centrally-hosted applications according to one or more illustrative aspects described herein.

FIG. 6 depicts a flowchart diagram of an example process for monitoring of web applications and/or centrally-hosted applications according to one or more illustrative aspects described herein.

FIG. 7 is a flowchart diagram of an example process for updating entitlements associated with software applications in an application provisioning system. according to one or more illustrative aspects described herein

### DETAILED DESCRIPTION

As discussed above, there is need for improved control and monitoring of access/entitlements to applications associated with an application database system (e.g., a centralized database system) of an organization. Systems and methods may be used to, among other things, monitor access, by a user, to one or more web applications such that an organization is aware of a number of uses of a software license associated with the accessed web applications. Additionally these systems and methods may be used to monitor access, by a user, to one or more applications stored locally on a user's computer system, such that an organization may ensure that the one or more applications stored locally on the user's computer system are in compliance with software updates.

Throughout this disclosure, reference may be made to one or more organizations, wherein an organization may be, among other entities, a business enterprise, a university, a research group, or any collection of people accessing one or more software applications from an application database. Accordingly, a user, as associated with an organization, may be, for example, an employee, a student, a researcher, or generally, an individual from which access to one or more software applications is requested. Additionally, those of ordinary skill will recognize that this disclosure may relate to organizations of varying sizes, and having associated users numbering in the tens, hundreds, or thousands or greater. Where an organization is described as a business enterprise (or alternatively referred to as a company, a corporation, or simply, a business), it will be understood that such business enterprises may be small and medium enterprises (SMEs), or multinational corporations (MNCs). Furthermore, this disclosure should not be limited by the types of operations/tasks undertaken by an organization, as aided by one or more software applications. For example, this disclosure may relate to operations associated with financial services, scientific research, academia, or manufacturing, among many others. As such, a software application, as described herein, may include any computer program configured to be executed on/interfaced with a desktop computer, a laptop computer, a virtual computer, or a mobile device, including tablets, mobile phones (smart phones), and the like.

In one arrangement, aspects of the disclosure relate to an application provisioning system, wherein provisioning may include one or more processes for monitoring access to/execution of one or more software applications. Aspects described herein relate to entitlements. Entitlements may include one or more provisioning rules and/or processes associated with access to/execution of one or more software applications. Furthermore, these entitlements may be sub-divided into application provisioning rules and user provisioning rules. Application provisioning rules may include one or more specifications detailing a type of hardware on which an application may be executed/accessed, hardware resources that will be requested in order to execute an application, and information related to a version number/revision number of a software application, among others. User provisioning rules may include one or more specifications detailing a sub-group of an organization to which the user is a part, a title of the user (e.g., a level of seniority of a user, or a job title of the user, among others), and a list of those applications for which a user has permission to access, among others.

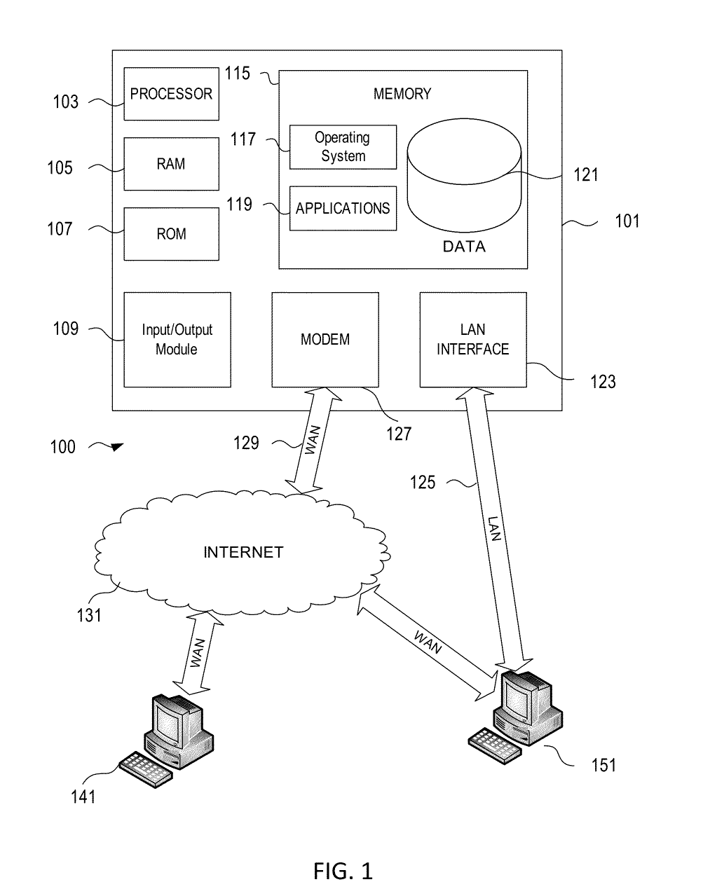

In one embodiment, an application provisioning system, as described herein, may be implemented by dedicated or shared computing hardware, such as computing device 101 from FIG. 1.

FIG. 1 illustrates a block diagram of an exemplary configuration of a system 100 for monitoring access and/or entitlements associated with software applications in a centralized application database system of an organization. System 100 may include one or more application provisioning systems, wherein an application provisioning system may be implemented by one or more computing devices, such as computing device 101. Computing device 101 may have a processor 103 for controlling the overall operation of the computing device 101 (e.g., by executing instruction stored in memory) and other components, including RAM 105, ROM 107, an input/output (I/O) module 109, and additional memory 115.

I/O module 109 may include a microphone, keypad, touch screen, and/or stylus through which a user of the computing device 101 may provide input, and may also include one or more of a speaker for providing audio output and a video display device for providing textual, audiovisual and/or graphical output. Software may be stored within memory 115 and/or storage to provide instructions to the processor 103 for supporting the computing device 101 in performing various functions. For example, memory 115 may store software used by the computing device 101, such as an operating system 117, application programs 119, and an associated database 121. The processor 103 and its associated components may allow the computing device 101 to run a series of computer-readable instructions to monitor access and/or entitlements associated with software applications, and wherein the data associated with the software applications is stored in one or more centralized application databases operated and maintained by an organization.

The computing device 101 may operate in a networked environment supporting connections to one or more remote computers, such as terminals 141 and 151. The terminals 141 and 151 may be personal computers or servers that include many or all of the elements described above relative to the computing device 101. Alternatively, terminal 141 and/or 151 may be a data store that is affected by the operation of the alert management module 101. The network connections depicted in FIG. 1 include a local area network (LAN) 125 and a wide area network (WAN) 129, but may also include other networks. When used in a LAN networking environment, the computing device 101 is connected to the LAN 125 through a network interface or adapter 123. When used in a WAN networking environment, the computing device 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed.

Additionally, an application program 119 used by the computing device 101 according to an illustrative embodiment of the disclosure, may include computer-executable instructions for invoking functionality related to monitoring access to one or more applications. Additionally, application program 119 may include computer-executable instructions for invoking functionality related to monitoring entitlements related to one or more applications.

The computing device 101 and/or terminals 141 or 151 may also be mobile terminals, such as smart phones, personal digital assistants (PDAs), and the like, which may include various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, and distributed computing environments that include any of the above systems or devices, and the like.

The disclosure may be described in the general context of computer-executable instructions, such as program modules, being executed by a computer. Generally, program modules include routines, programs, objects, components, data structures, and the like that perform particular tasks or implement particular abstract data types. The disclosure may also be practiced in distributed computing environments where tasks are performed by remote processing devices that are linked, for example, through a communications network. In a distributed computing environment, program modules may be located in both local and remote computer storage media including memory storage devices.

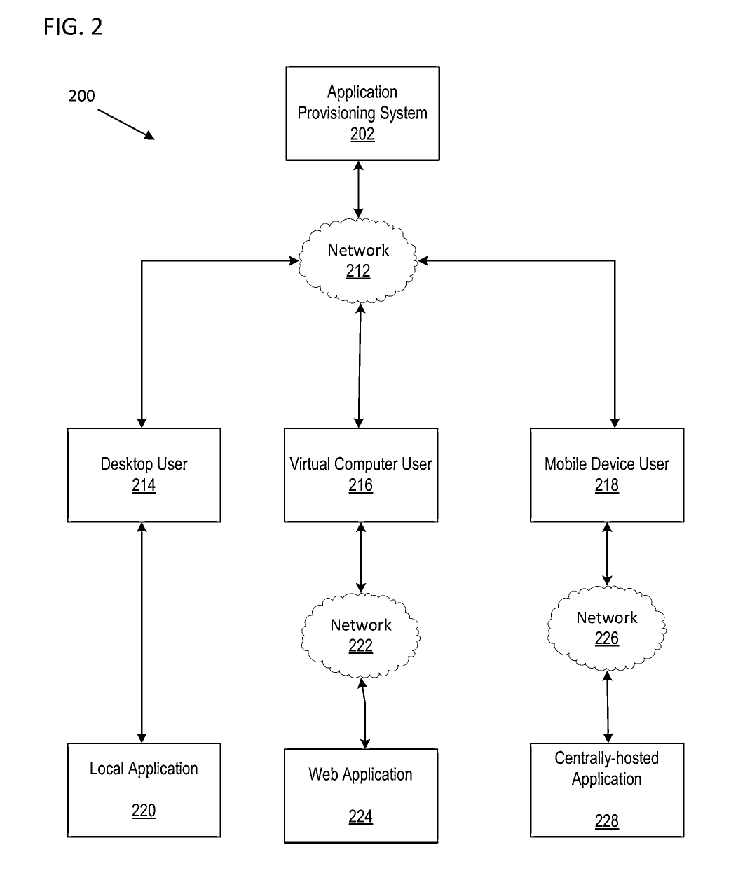

FIG. 2 is a schematic block diagram of an application network 200 that includes an application provisioning system 202, wherein application provisioning system 202 may be implemented by, among others, computing device 101 from FIG. 1. Accordingly, application provisioning system 202 may be hosted on hardware associated with one or more server computers (e.g. computing device 101), and wherein the server computers may be centralized in a single server rack, server room, and/or datacenter, or distributed across one or more networks. Additionally, application network 200 further includes network 212, desktop user 214, virtual computer user 216, mobile device user 218, local application 220, network 222, web application 224, network 226, and centrally-hosted application 228. Accordingly, FIG. 2 schematically depicts communication between users utilizing different forms of computer system hardware, and an application provisioning system 202.

It will be readily understood to those of ordinary skill that FIG. 2 merely depicts one exemplary arrangement of application network 200, and many other embodiments and/or permutations of the depicted components may be envisioned, without departing from the scope of this disclosure. In particular, application network 200 depicts three users (214, 216, and 218), which may be representative of a much larger number of users of application network 200. Alternatively, application network 200 may be implemented with only one or two of users 214, 216, and 218. Furthermore, while local application 220 is depicted in communication with desktop user 214, web application 224 is depicted in communication (via network 222) with virtual computer user 216, and centrally-hosted application 228 is depicted in communication with (via network 226) mobile device user 218, other alternative embodiments of this application network 200 may be used, without departing from the scope of this disclosure. For example, desktop user 214 may communicate with one or more of a local application, such as local application 220, a web application, such as web application 224, and/or a centrally-hosted application, such as centrally-hosted application 228, and wherein this communication may be via network, such as network 222 or network 226. Similarly, virtual computer user 216 and mobile device user 218 may communicate with one or more of a local application, such as local application 220, a web application, such as web application 224, and/or a centrally-hosted application, such as centrally-hosted application 228, and via network, such as network 222 or 226, and the like.

In the illustrated example, desktop user 214 may communicate with network 212 using a desktop computer, wherein said desktop computer may be a general-purpose, or a special-purpose computer system. Accordingly, various embodiments of computer systems comprising at least a central processing unit and a form of memory storing instructions that may be executed by the central processing unit will be readily apparent to those of skill in the art. Furthermore, virtual computer user 216 may access network 212 using a virtual computer, wherein a virtual computer, otherwise referred to as a virtual machine, provides functionality of computer system hardware using a software implementation of said computer system hardware. Accordingly, a user 216 may access a virtual machine through an additional computer system hardware interface. Additionally, mobile device user 218 may access network 212 from mobile device hardware, which may be a tablet computer, or a mobile phone (otherwise referred to as a smartphone, and the like).

Network 212 may be implemented as a local area network (LAN), a storage area network (SAN), a wide area network (WAN), a metropolitan area network (MAN), the Internet, or any other type of network infrastructure or communication system for transferring information between computer systems. Additionally, those network links between desktop user 214, virtual computer user 216, mobile device user 218, and network 212 may be wired or wireless, and use one or more network protocols, such as Hyper Text Transfer Protocol (HTTP), Secure Hyper Text Transfer Protocol (HTTPS), Secure Socket Layer (SSL), Secure Shell (SSH), Transport Layer Security (TLS), Fibre Channel network protocols, Internet Protocol Suite (TCP/IP), Bluetooth Protocol, among others.

As depicted in FIG. 2, desktop user 214, virtual computer user 216, and mobile device user 218 may be connected to application provisioning system 202 via network 212. Accordingly, application provisioning system 202 may execute one or more processes to control and/or monitor access, by one or more of users 214, 216, and 218, to one or more software applications. In one arrangement, data associated with said software applications may be stored in application provisioning system 202, wherein said data may be, among others, an installation/executable file that may be downloaded to local hardware associated with a user 214, 216, or 218. Additionally or alternatively, application data stored in application provisioning system 202 may include links to one or more web applications, or may be one or more hosted applications (e.g., centrally hosted application such as software as a service (SaaS) applications, or cloud computing applications).

Accordingly, a user, such as desktop user 214, may download an application from application provisioning system 202, via network 212. A downloaded application, represented by local application 220, may be stored and accessed locally in memory of the hardware associated with desktop user 214. Additionally or alternatively, a user, such as virtual computer user 216, may access a web application 224 via application provisioning system 202. Furthermore, a web application, such as web application 224, may alternatively be accessed by a desktop user 214, or a mobile device user 218. Accordingly, web application 224 may be hosted by separate computer hardware associated with a separate organization. As such, virtual computer user 216 may access web application 224 via network 222, and network 222 may be implemented as a local area network (LAN), a storage area network (SAN), a wide area network (WAN), a metropolitan area network (MAN), the Internet, or any other type of network infrastructure or communication system for transferring information between computer systems. Similarly, mobile device user 218 may access a centrally-hosted application 228, which may be hosted by separate computer hardware associated with a separate, or a same organization to that of mobile device user 218. Additionally, mobile device user 218 may access centrally-hosted application 228 via network 226, wherein network 226 may also be implemented as a local area network (LAN), a storage area network (SAN), a wide area network (WAN), a metropolitan area network (MAN), the Internet, or any other type of network infrastructure or communication system for transferring information between computer systems.

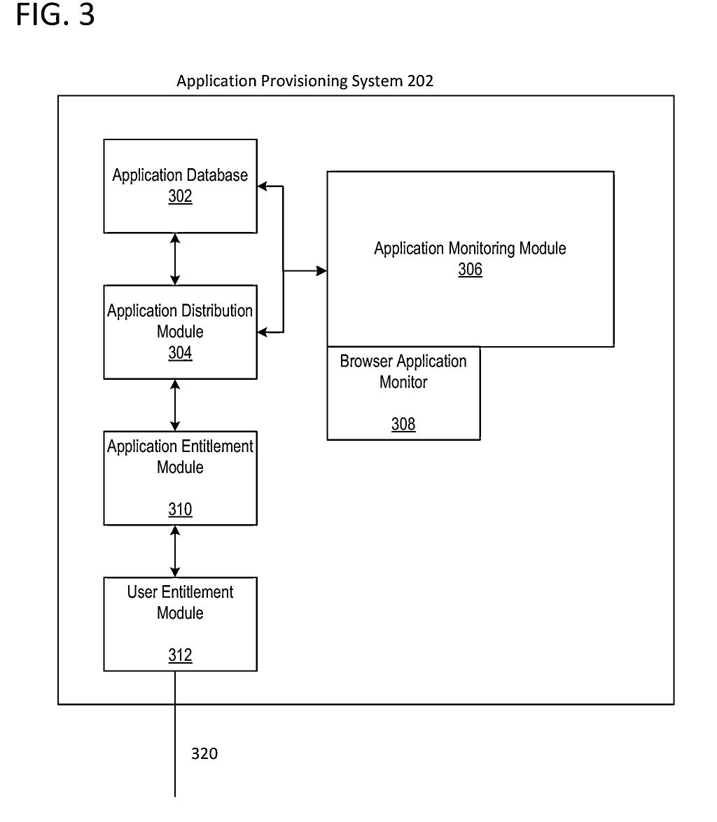

FIG. 3 is a schematic block diagram of an application provisioning system 202. In particular, FIG. 3 includes a network link 320, an application database 302, an application distribution module 304, an application monitoring module 306, a browser application monitor 308, an application entitlement module 310, and a user entitlement module 312. As previously described, the application provisioning system 202 may execute one or more processes to control and/or monitor access to one or more software applications. Accordingly, the various components of application provisioning system 202, as depicted in FIG. 3, may be implemented using dedicated hardware components, such as application-specific integrated circuits (ASICs), or central processing units (CPUs), and the like. Alternatively, the components of application provisioning system 202, as depicted in FIG. 3, may be implemented as one or more processes executed by shared hardware components. Furthermore, application provisioning system 202 may generate a graphical user interface for communication with one or more users, and such that a user may interact with this graphical user interface to access one or more software applications. Accordingly, the graphical user interface may be hosted on an intranet internal to an organization, the Internet, or any other network type, such that the graphical user interface may be accessed via a web browser, among others. Furthermore, one or more identification processes may be executed to identify one or more users requesting access to the graphical user interface as being associated with the organization that hosts and maintains application provisioning system 202.

In one arrangement, application database 302 stores data related to one or more software applications. As previously described, a software application may take any known form, and comprise one or more processes and/or computational tasks executed by computational hardware associated with a computer system. Examples of software applications may include, among many others, financial software tools, engineering design tools, computer programming environments, videogames, document viewer programs, web browsers, and media players, and the like. In one configuration, application database 302 may store a file comprising data that may be used to install an application on a local client computer. In particular, desktop user 214, virtual computer user 216, and/or mobile device user 218 from FIG. 2 may be regarded as examples of local client computers. In another embodiment, application database 302 may store one or more links to one or more web applications. A link may be a uniform resource locator (URL), or domain name, among others, that may direct a user from application provisioning system 202 to a web application that is hosted externally to the application provisioning system 202 associated with an organization. As such, a web application may be accessed by one or more users via the Internet, wherein communication with a web application may be established using a web browser. Furthermore, a web application may be hosted remotely by hardware associated with a web application vendor and/or publisher.

In yet another embodiment, application database 302 may store one or more links to centrally-hosted applications (e.g., software as a service (SaaS), on-demand software, and/or cloud computing applications). As such, centrally-hosted applications may run from centralized hardware shared among multiple users, and wherein said centralized hardware may be operated and maintained by the same organization as application provisioning system 202 (and with which the multiple users are associated), or by a third-party organization separate from the organization associated with application provisioning system 202.

Additionally, application database 302 may store information related to one or more licenses for software applications. This software application license information may include, among others, version information from one or more software applications. For example, the license information may allow one or more users associated with an organization to access one or more specific versions and/or revisions of a software application. Furthermore, the license information may include a total number of licenses available to an organization for one or more software applications. For example, an organization may purchase a number of licenses for a software application, wherein the number of licenses is less than, equal to, or greater than, a number of users associated with the organization. In another configuration, application database 302 may store statistical data related to access of one or more software applications. This statistical data may include a number of times that one or more users accessed a software application, a total amount of time spent by one or more users interacting with a software application, and a date and time associated with a last access of a software application by one or more users, among others.

User entitlement module 312 may store one or more user provisioning rules associated with one or more users within an organization. User provisioning rules may include, among others, specifications detailing a sub-group of an organization of which the user is a part, a title of the user (which may be a level of seniority of a user, or a job title of the user, a sub-group of a corporation with which the user is associated, among others), and a type of computational hardware (desktop computer, laptop computer, virtual machine, or mobile device, among others) from which a request for access to software applications is received.

In one configuration, user entitlement module 312 may receive a request from a user to access to a software application. A request may include information identifying the requesting user, wherein user entitlement module 312 may execute one or more processes to compare an identified requesting user to the one or more stored user provisioning rules. In another configuration, the one or more processes executed by the user entitlement module 312, in response to receipt of a request for access to a software application, may allow access to a requested software application if one or more user provisioning rules associated with the requesting user specify that the user is allowed to access the requested software application.

Application entitlement module 310 may store one or more application provisioning rules associated with one or more software applications, wherein data associated with the one or more software applications may be stored in application database 302. In one example, the one or more application provisioning rules may include, among others, one or more user-type rules (a job title of a user, the level of seniority of the user, a sub-group of a corporation with which the user is associated, among others) specifying those types of users who may access one or more software applications. Additionally, the one or more application provisioning rules may include one or more hardware rules specifying, among others, one or more types of computational hardware on which one or more software applications may be run/executed/viewed. Further, one or more application provisioning rules may include version rules specifying one or more updates/revisions to one or more software applications that, in one configuration, must be made in order to comply with software license agreements and/or other regulatory conditions. For example, for a financial institution, certain financial software applications may be updated to comply with one or more financial regulatory conditions.

Application distribution module 304 may execute one or more processes to communicate access, to a user of application provisioning system 202, to one or more software applications. In one arrangement, application distribution module 304 provides access to one or more software applications by executing one or more processes to download a software application to a local computer associated with a user. A local computer may be, among others, a desktop computer, a laptop computer, a tablet, a smart phone, or a virtual machine, and associated with the specific user requesting access. A downloaded software application may be stored in persistent or volatile memory associated with the local computer hardware (client computer), and execute one or more processes in fulfillment of one or more tasks associated with the software application.

In one embodiment, a downloaded software application that executes on a client computer, such as desktop user 214 from FIG. 2, may be in persistent communication with application provisioning system 202 via network 212. However, in another configuration, client computer (desktop user 214) may communicate intermittently with application provisioning system 202 via network 212 while executing a downloaded software application, such as local application 220.

In another configuration, application distribution module 304 may execute one or more processes to facilitate access to one or more software applications hosted centrally in an organization, or hosted remotely from an organization. In one embodiment, application distribution module may communicate a link to a user, wherein the link may direct the user to a web application hosted by a separate organization to that associated with application provisioning system 202. In another embodiment, application distribution module may communicate a link to direct a user to a centrally-hosted application within the organization associated with application provisioning system 202.

In one configuration, application monitoring module 306 may execute one or more processes to monitor use of one or more software applications associated with application provisioning system 202. Specifically, for downloaded software applications, such as local application 220 from FIG. 2, application monitoring module 306 may execute one or more processes to run a monitoring agent on a client computer, such as desktop user 214. This monitoring agent may communicate data related to a number of uses of a downloaded software application, a total use time of the software application, and a time that a software application was last used, among others.

Browser application monitor 308 may execute one or more processes to monitor use of one or more web applications by a user. For example, a user may access a web application through a web browser, wherein multiple web browsers are well known to those skilled in the art. Browser application monitor 308 may, in one configuration, communicate data to application database 302, wherein the communicated data may include a total number of uses/accesses of a web application, an estimated total time of use of a web application by a user, and a last time of use of a web application by a user, among others. In one embodiment, browser application monitor 308 may execute one or more processes to search a browser history associated with a user, and correlate one or more URLs from the browser history with one or more respective URLs associated with web applications to which application provisioning system 202 provides access. In this way, browser application monitor 308 may communicate data related to a number of uses of a licensed software application, to application database 302, without relying on a publisher of the web application, which may be separate to the corporation that operates and maintains application provisioning system 202, to provide this access information. Furthermore, this monitoring, by the browser application monitor 308, of access to one or more web applications may be carried out by application provisioning system 202 on a downstream side of the one or more web applications, wherein a downstream side of one or more web applications refers to the hardware, and supporting software and firmware, for accessing a web application that is hosted and/or made available from another location (by a third party). For example, a web application may be accessible on one or more servers associated with a third party company that is separate to a corporation with which a user is associated. Accordingly, the hardware, and supporting software and firmware used by the user to access the exemplary web application may be referred to as being on a downstream side of the web application (the receiving side). Furthermore, the hardware, and associated software and firmware (the servers, and the like) associated with hosting the web application may be referred to as an upstream side (the transmitting side) of the exemplary web application.

Additionally or alternatively, browser application monitor 308 may execute one or more processes to monitor use of one or more web applications by storing periodic screen captures of a web browser associated with the user. For example, browser application monitor 308 may generate and/or store one or more screenshots of the content displayed on a web browser at predetermined time intervals. From the stored screenshot information, browser application monitor 308 may determine that a user accessed a web application associated with application provisioning system 202. Furthermore, the stored screenshot information may be used to infer a total amount of time that a user accessed one or more software applications. Specifically, browser application monitor 308 may identify one or more licensed software applications associated with application provisioning system 202 by executing one or more recognition processes that may recognize one or more images and/or lines of text associated with a web application.

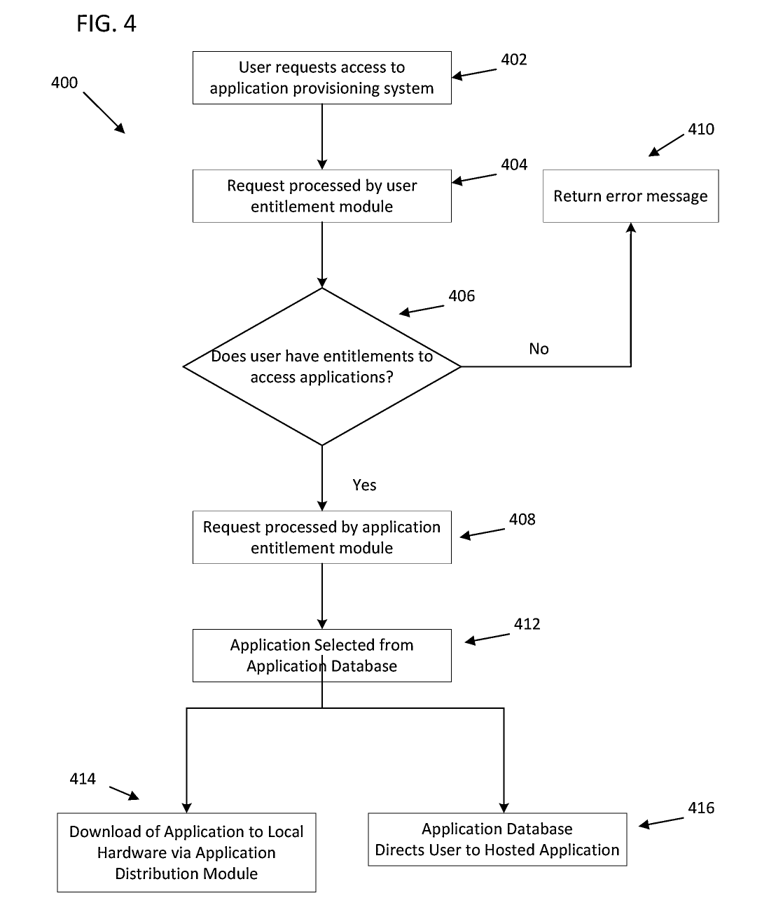

FIG. 4 is a flowchart diagram of an example application access process 400. In one example, application access process 400 may be implemented by application provisioning system 202 to grant access for a user to one or more software applications. In particular, process 400 begins at block 402 with a request from a user to access application provisioning system 202. Process 400 proceeds to block 404 where the request from the user is received and processed by a user entitlement module 312. As previously described, a request from a user for access to application provisioning system 202 may include data identifying a user and/or information related to computational hardware from which a request was sent. Accordingly, a user entitlement module 312 may execute one or more processes to compare user identification data with stored user provisioning rules, wherein user provisioning rules may include, among others, information related to the type of applications to which a user may be granted access, data related to a sub-group of an organization with which the user is associated, a title of a user, and a list of those applications for which a user has permission to access.

Block 406 of process 400 represents a decision point, wherein upon receipt of a request to access one or more software applications, user entitlement module 312 may grant or deny access. If user entitlement module 312 grants access to the requesting user to access the one or more requested software applications, process 400 proceeds to block 408, wherein the user request is further processed by application entitlement module 310. If, however, user entitlement module 312 determines that a user is not entitled to gain access to a requested software application, process 400 proceeds to block 410, whereby an error message is returned to the requesting user. Additionally, upon determining that a user is not entitled to gain access to a requested software application, user entitlement module 312 may store data related to a denied request in application database 302.

Returning to block 408, application entitlement module 310, upon receipt of a request for access to one or more applications, may execute one or more processes to compare the request to one or more application provisioning rules. As previously discussed, one or more application provisioning rules may include, among others, one or more user-type rules specifying those types of users who may access one or more software applications. Additionally, the one or more application provisioning rules may include one or more hardware rules that specify, among others, one or more types of computational hardware with which requested software applications may be interacted. Accordingly, upon receipt of a request for access to one or more software applications, application entitlement module 310 may execute one or more processes to display only those software applications for which the requesting user has permission to access, and/or only those software applications compatible with the computational hardware being used by the requesting user. For example, application entitlement module 310 may only display, via a graphical user interface displayed on, among others, a web browser, those software applications for a desktop computer if it is determined that a user has requested access to one or more software applications from a desktop computer. Additionally or alternatively, application entitlement module 310 may execute one or more processes to display one or more software applications for which the requesting user has permission to access, based on one or more of a job title, a level of seniority, or a sub-group of a corporation associated with the requesting user. Furthermore, the user requesting access may be unaware of one or more restrictions associated with the application provisioning rules. For example, the user may be presented with only those applications to which he/she has access, based on his/her job title etc., and wherein the

Process 400 may proceed to block 412 upon processing of a request for access to one or more software applications by application entitlement module 310. Block 412 represents one or more processes executed to select a requested one or more software applications from application database 302. Accordingly, if data associated with a selected software application represents a downloadable file to be installed locally, process proceeds to block 414 wherein application distribution module 304 executes one or more processes to download the requested application to the computational hardware from which a request has been received or to another designated hardware device. If, however, a requested one or more software applications includes one or more web applications (and/or centrally-hosted applications), process 400 proceeds to block 416, and application database 302 directs the requesting user to the web applications (and/or centrally-hosted applications).

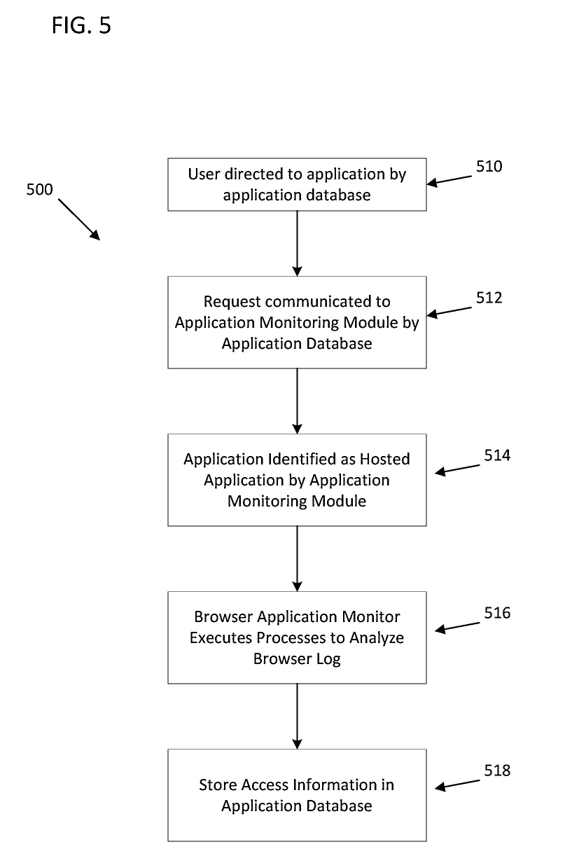

FIG. 5 is a flowchart diagram of a process 500 for monitoring of web applications and/or centrally-hosted applications. In particular, process 500 begins at block 510, wherein, subsequent to receipt of a request from a user for access to one or more software applications, application database 302 directs the user to the requested applications. In this exemplary process 500, the requested software applications may be web applications, however one of ordinary skill will recognize that the requested software applications may be centrally-hosted applications associated with an organization, without departing from the scope of this disclosure.

Upon direction, by application database 302, of a user to a requested software application, process 500 proceeds to block 512. Block 512 represents one or more processes executed to communicate a request for monitoring of usage patterns of software applications. Further, this request may be communicated to application monitoring module 306, and from application database 302. In response, and as indicated at block 514, application monitoring module 306 may identify an application to which the user was directed as a hosted application (web application).

Block 516 represents one or more processes executed by a browser application monitor 308 to monitor access, by one or more users, to one or more web applications. In particular, browser application monitor 308 may collect and store data related to usage of one or more web applications through a web browser. In one configuration, browser application monitor 308 may execute one or more processes to analyze a web browser log, otherwise referred to as a browser history. Accordingly, browser application monitor 308 may compare one or more entries in a web browser history to one or more URLs associated with software applications. In this way, browser application monitor 308 may determine that a user has accessed a web application to which an organization associated with the user has purchased a software license. Additionally, browser application monitor 308 may record information related to a total time spent by a user accessing a web application.

Process 500 continues to block 518, wherein, upon execution of one or more processes by browser application monitor 308, one or more data points related to access statistics are stored in an application database 302. In this way, information related to a number of accesses of a software application, a total time spent using a software application, or a last time that a software application was used, may be stored in an application database 302, and associated with one or more respective software applications.

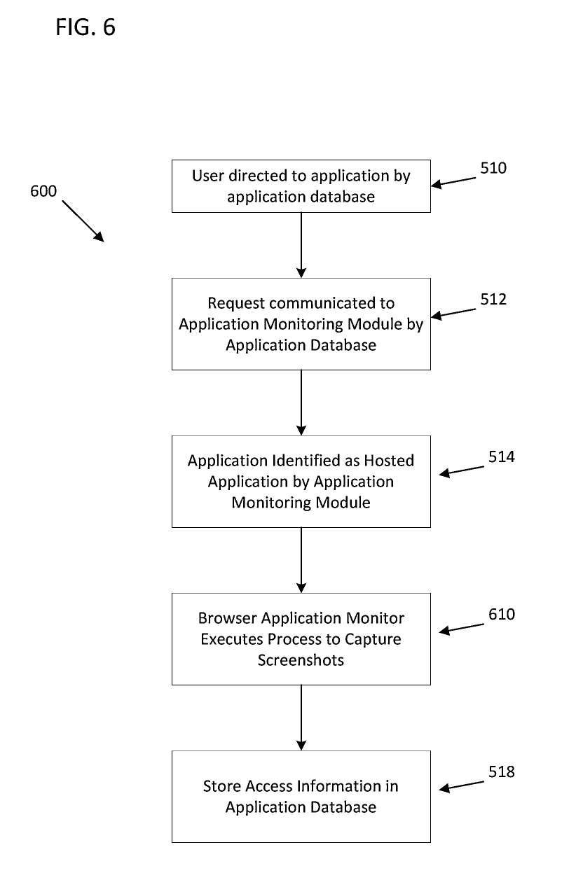

FIG. 6 depicts a flowchart diagram of a process 600 for monitoring of applications such as web applications and/or centrally-hosted applications. Process 600 may be similar to processor 500 from FIG. 5, wherein application monitoring module 306 is utilized to monitor one or more accessed web applications. In particular, process 600 includes block 610, wherein browser application monitor 308 executes one or more processes to monitor access to one or more software applications through a web browser. Specifically, block 610 represents one or more processes executed by browser application monitor 308 to capture one or more screenshots of a web browser. Accordingly, the one or more captured screenshots may be used to identify one or more web applications used by a user. In this way, browser application monitor 308 may execute one or more image recognition processes on the one or more captured screenshots such that one or more web applications may be recognized. Further, browser application monitor 308 may store one or more data points in application database 302 related to usage statistics associated with one or more web applications, and independent of any records kept by a publisher of the one or more web applications.

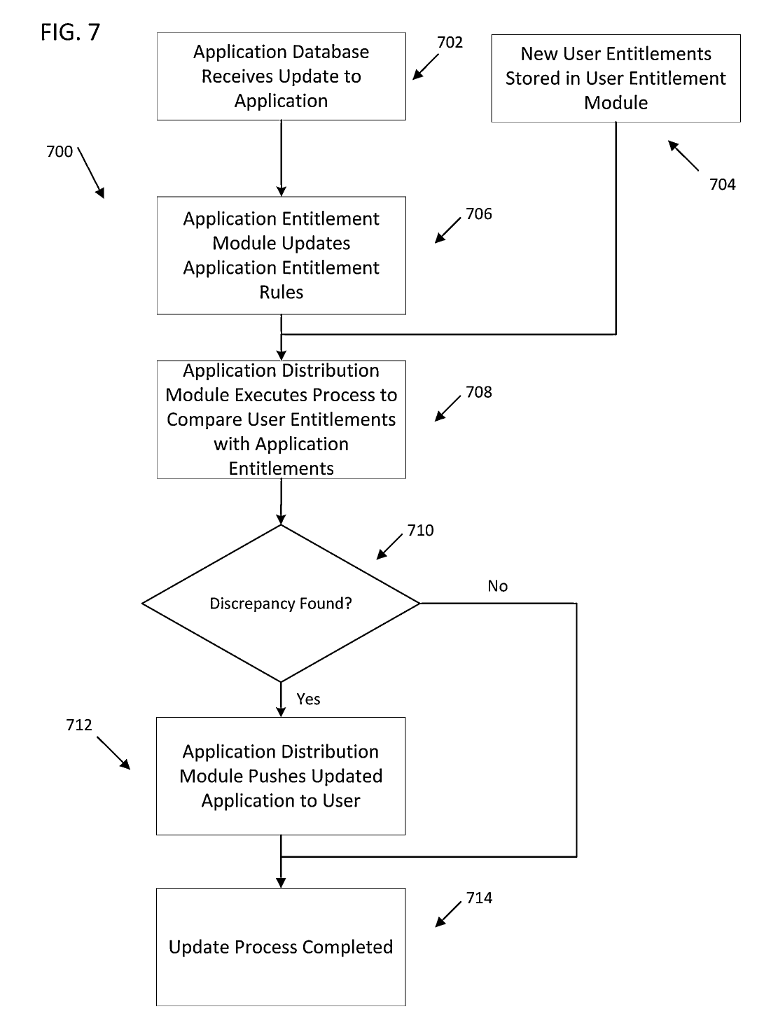

FIG. 7 is a flowchart diagram of a process 700 for updating entitlements associated with software applications in an application provisioning system 202. Process 700 may begin at block 702 upon receipt, by application database 302 of one or more updates to a software application. In response, process 700 proceeds to block 706, wherein application entitlement module 310 updates one or more application entitlements (application provisioning rules). For example, block 706 may represent an update to one or more application entitlements (application provisioning rules) specifying a current version of a given software application that is to be updated on one or more users' computers. Alternatively, process 700 may begin at block 704, wherein block 704 represents a receipt of one or more new user entitlements (user provisioning rules) into user entitlement module 312. For example, block 704 may represent a change in job title associated with the user, wherein a change in job may correspond to one or more new software applications available to the respective user.

Process 700 proceeds to block 708 as application distribution module 304 executes one or more processes to compare one or more user provisioning rules with one or more application provisioning rules. Process 700 further proceeds to block 710, which represents a decision point. If, in response to a comparison, by application distribution module 304, a discrepancy is found between one or more user provisioning rules and one or more respective application provisioning rules, process 700 proceeds to block 712. Accordingly, block 712 represents one or more processes executed by application distribution module 304 to distribute (e.g., push or transmit in response to an update request) one or more software application updates to one or more users associated with respective user provisioning rules with which a discrepancy was found. For example, upon receipt of an update to a financial software application, application distribution module 304 may compare one or more updated application provisioning rules with one or more user provisioning rules. In one embodiment, one or more user provisioning rules may specify that a user should use a most up-to-date version of a software application. Accordingly, an application distribution module 304 will detect a discrepancy between the user provisioning rules and the application provisioning rules for this user with regard to this updated software application. As a result, application distribution module 304 will execute one or more processes to push the corresponding software application updates to the respective user.

Subsequently, process 700 proceeds to block 714, wherein block 714 represents a completion of entitlement update process 700. Accordingly, if no discrepancy is found at block 710, process 700 proceeds directly to block 714, as indicated in FIG. 7.

As noted above, application provisioning system 202 may allow for monitoring of access to web applications by an organization independent of and/or separate from a publisher of the web applications. As such, usage statistics may be captured and stored by application provisioning system 202 related to web applications, and such that an organization associated with the user may monitor use of licensed software applications independent of those usage statistics provided by a web application publisher. Advantageously, these systems and methods for monitoring usage of web applications, by application provisioning system 202, may be used by an organization to, in one example, negotiation license agreements with software application vendor or based on usage statistics monitored and stored by application provisioning system 202. These monitoring processes are described in greater detail in relation to FIG. 3, FIG. 5, and FIG. 6.

Furthermore, the systems and methods described herein may be used to update entitlements associated with one or more software applications and one or more respective users. Advantageously, these systems and methods determine that access to/updating of one or more software applications is to be carried out based on a combination of both user provisioning rules and application provisioning. Accordingly, these systems and methods are described in greater detail in relation to FIG. 3, and FIG. 7, among others.

Some embodiments of the above described may be conveniently implemented using a conventional general purpose or a specialized digital computer or microprocessor programmed according to the teachings herein, as will be apparent to those skilled in the computer art. Appropriate software coding may be prepared by programmers based on the teachings herein, as will be apparent to those skilled in the software art. Some embodiments may also be implemented by the preparation of application-specific integrated circuits or by interconnecting an appropriate network of conventional component circuits, as will be readily apparent to those skilled in the art. Those of skill in the art would understand that information and signals may be represented using any of a variety of different technologies and techniques. For example, data, instructions, requests, information, signals, bits, symbols, and chips that may be referenced throughout the above description may be represented by voltages, currents, electromagnetic waves, magnetic fields or particles, optical fields or particles, or any combination thereof.

Some embodiments include a computer program product comprising a computer readable medium (media) having instructions stored thereon/in and, when executed (e.g., by a processor), perform methods, techniques, or embodiments described herein, the computer readable medium comprising sets of instructions for performing various steps of the methods, techniques, or embodiments described herein. The computer readable medium may comprise a storage medium having instructions stored thereon/in which may be used to control, or cause, a computer to perform any of the processes of an embodiment. The storage medium may include, without limitation, any type of disk including floppy disks, mini disks (MDs), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any other type of media or device suitable for storing instructions and/or data thereon/in. Additionally, the storage medium may be a hybrid system that stored data across different types of media, such as flash media and disc media. Optionally, the different media may be organized into a hybrid storage aggregate. In some embodiments different media types may be prioritized over other media types, such as the flash media may be prioritized to store data or supply data ahead of hard disk storage media or different workloads may be supported by different media types, optionally based on characteristics of the respective workloads. Additionally, the system may be organized into modules and supported on blades configured to carry out the storage operations described herein.

Stored on any one of the computer readable medium (media), some embodiments include software instructions for controlling both the hardware of the general purpose or specialized computer or microprocessor, and for enabling the computer or microprocessor to interact with a human user and/or other mechanism using the results of an embodiment. Such software may include without limitation device drivers, operating systems, and user applications. Ultimately, such computer readable media further includes software instructions for performing embodiments described herein. Included in the programming (software) of the general-purpose/specialized computer or microprocessor are software modules for implementing some embodiments.

Accordingly, it will be understood that the invention is not to be limited to the embodiments disclosed herein, but is to be understood from the following claims, which are to be interpreted as broadly as allowed under the law.

Those of skill would further appreciate that the various illustrative logical blocks, modules, circuits, techniques, or method steps of embodiments described herein may be implemented as electronic hardware, computer software, or combinations of both. To illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the embodiments described herein.

The various illustrative logical blocks, modules, and circuits described in connection with the embodiments disclosed herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The techniques or steps of the methods described in connection with the embodiments disclosed herein may be embodied directly in hardware, in software executed by a processor, or in a combination of the two. In some embodiments, any software module, software layer, or thread described herein may comprise an engine comprising firmware or software and hardware configured to perform embodiments described herein. In general, functions of a software module or software layer described herein may be embodied directly in hardware, or embodied as software executed by a processor, or embodied as a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read data from, and write data to, the storage medium. In the alternative, the storage medium may be integral to the processor. The processor and the storage medium may reside in an ASIC. The ASIC may reside in a user device. In the alternative, the processor and the storage medium may reside as discrete components in a user device.

What is claimed is:

1. An apparatus, comprising:
a processor; and
memory storing computer-readable instructions that, when executed by the processor, cause the apparatus to:
store links, in an application database, to one or more applications that are accessible through an Internet connection;
process, by an application entitlement module, one or more application provisioning rules associated with the one or more applications;
process, by a user entitlement module, one or more user provisioning rules associated with a user;
provide access, by an application distribution module, in response to a request from the user, to the one or more applications, based upon the one or more application provisioning rules and the one or more user provisioning rules; and
monitor access from a downstream side of the one or more applications, by an application monitoring module, to the one or more applications to which the user is provided access.

2. The apparatus of claim 1, wherein the computer-readable instructions, when executed by the processor, further cause the apparatus to:
monitor, by the application monitoring module, a number of uses of one or more licenses associated with the one or more applications.

3. The apparatus of claim 1, wherein the computer-readable instructions, when executed by the processor, further cause the apparatus to:
monitor access, by a browser monitoring module, to the one or more applications based on a web browser history associated with the user.

4. The apparatus of claim 1, wherein the computer-readable instructions, when executed by the processor, further cause the apparatus to:
monitor access, by a browser monitoring module, to the one or more applications based on one or more screen captures from a web browser associated with the user.

5. A method comprising:
storing, in an application database, one or more Internet links to one or more applications;
receiving, by an application distribution module, a request from a user for access to a selected one or more of the one or more applications;
processing, by an application entitlement module, in response to the request for access, one or more application provisioning rules associated with the selected one or more applications;
processing, by a user entitlement module, in response to the request for access, one or more user provisioning rules associated with the user; and
granting access to the user, by an application distribution module, to the selected one or more applications, based upon the processed one or more application provisioning rules and the one or more user provisioning rules.

6. The method of claim 5, further comprising:
monitoring access from a downstream side of the one or more applications, by an application monitoring module.

7. The method of claim 6, wherein the application monitoring module monitors a number of uses of one or more licenses associated with the one or more applications

8. The method of claim 6, further comprising:
monitoring access to the one or more applications, by a browser monitoring module, based on a web browser history associated with the user.

9. The method of claim 6, further comprising:
monitoring access to the one or more applications, by a browser monitoring module, based on one or more screen captures from a web browser associated with the user.

10. The method of claim 6, further comprising:
storing, in the application database, a number of times that a license associated with the one or more applications is used.

11. An apparatus comprising:
an application database, for storing data related to a plurality of applications;
an application entitlement module, for storing one or more application provisioning rules associated with one or more of the plurality of applications;
a user entitlement module, for storing one or more user provisioning rules associated with one or more users; and
an application distribution module, for providing access, in response to a request from a selected user from the one or more users, to a selected application from the plurality of applications, based upon the one or more application provisioning rules and the one or more user provisioning rules.

12. The apparatus of claim 11, further comprising:
an application monitoring module, for monitoring access to the plurality of applications.

13. The apparatus of claim 12, wherein the application monitoring module monitors a number of uses of one or more licenses associated with the plurality of applications.

14. The apparatus of claim 11, wherein a selected one or more of the plurality of applications are web applications accessed on through the Internet.

15. The apparatus of claim 14, further comprising:
a browser monitoring module, for monitoring access to the selected one or more applications based on one or more screen captures from a web browser associated with one or more users.

16. The apparatus of claim 14, further comprising:
a browser monitoring module, for monitoring access to the selected one or more applications based on a web browser history associated with one or more users.

17. A non-transitory computer-readable storage medium having computer-executable program instructions store thereon that when executed by a processor cause an apparatus to perform steps comprising:
storing, in an application database, data related to a plurality of software applications;
storing, in an application entitlement module, one or more application provisioning rules associated with the plurality of software applications;
storing, in a user entitlement module, one or more user provisioning rules associated with one or more users;
updating the one or more user provisioning rules, based on a received update to one or more of the users' entitlements;
comparing, by an application distribution module, the one or more application provisioning rules and the one or more user provisioning rules; and
distributing, based on a discrepancy identified by the application distribution module between one or more application provisioning rules and one or more updated user provisioning rules, one or more application updates to one or more users associated with the received update.

18. The computer-readable storage medium of claim 17, wherein the computer-executable instructions, when executed by the processor, cause the apparatus to perform steps further comprising:
monitoring access, by an application monitoring module, to one or more of the plurality of software applications based on a number of uses of one or more licenses associated with the one or more of the plurality of software applications.

19. A non-transitory computer-readable storage medium having computer-executable program instructions store thereon that when executed by a processor cause an apparatus to perform steps comprising:
storing, in an application database, data related to a plurality of software applications;
storing, in an application entitlement module, one or more application provisioning rules associated with the plurality of software applications;
storing, in a user entitlement module, one or more user provisioning rules associated with one or more users;
updating, based on a received update to a selected one or more of the plurality of software applications, the one or more application provisioning rules;
comparing, by an application distribution module, the one or more application provisioning rules and the one or more user provisioning rules; and
distributing, based on a discrepancy identified by the application distribution module between one or more updated application provisioning rules and one or more of the one or more user provisioning rules associated with a selected one or more of the one or more users, the received update to the selected one or more users.

20. The computer-readable storage medium of claim 19, wherein the computer-executable instructions, when executed by the processor, cause the apparatus to perform steps further comprising:
monitoring access, by an application monitoring module, to one or more of the plurality of software applications based on a number of uses of one or more licenses associated with the one or more of the plurality of software applications.
